(19) United States
(12) Patent Application Publication
(10) Pub. No.: US 2007/0065627 A1
(43) Pub. Date: Mar. 22, 2007

(54) Water Board structure

(76) Inventors: Kung-Chao Chang, Taichung City (TW); Jim Chang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,820

(22) Filed: Dec. 30, 2005

(30) Foreign Application Priority Data
Sep. 22, 2005 (TW) 094216346

(51) Int. Cl. B32B 3/00

(52) U.S. Cl. 428/72; 428/73; 428/116; 428/178

(57) ABSTRACT

A board for water sport includes a reinforcement layer with an outer layer enclosing the reinforcement layer. The reinforcement layer includes at least one reinforcement block which includes a plurality of ribs arranged to define a plurality of chambers therebetween. The at least one reinforcement block has better structural strength while it is light in weight.

### FIELD OF THE INVENTION

The present invention relates to a board structure with a mediate including a plurality of chambers defined between ribs so as to have a light and strong board for water sport.

### BACKGROUND OF THE INVENTION

A conventional board 10 for water sport such as surfboard is shown in FIGS. 1 and 2 and generally includes a foam mediate 11 and an outer layer which encloses the foam mediate 11. The outer layer can be made by plastic, composite material or wooden material. The wooden material is heavy and is difficult to control. The mediate 11 is a solid piece which includes a large area and bears huge force when operating on the sea so that the structural strength of the mediate 11 is very important to the boards used for water sport. In order to have a strong mediate, the density of the mediate 11 has to be high so as to meet the requirements and the high density makes the boards to be heavy.

The present invention intends to provide a board for water sport and the board includes a mediate which includes a plurality of chamber defined by ribs such that the board can bear forces on the top and bottom of the board, and the board is light in weight.

### SUMMARY OF THE INVENTION

The present invention relates to a board for water sport and the board includes a reinforcement layer which includes at least one reinforcement block which includes a plurality of ribs arranged to define a plurality of chambers therebetween. An outer layer encloses the reinforcement layer and the ribs are substantially perpendicular to a top surface and a bottom surface of the board.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional board for water sport;

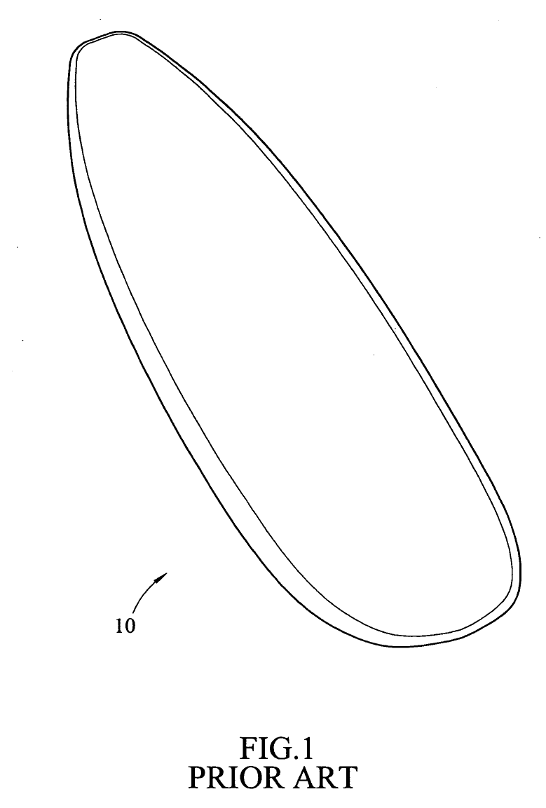

FIG. 2 is a cross sectional view to show the conventional board for water sport;

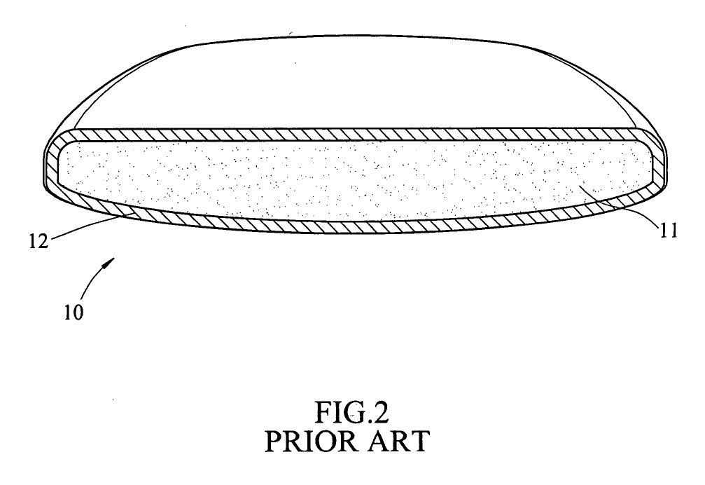

FIG. 3 shows the reinforcement layer and the outer layer of the board of the present invention;

FIG. 3A shows the reinforcement layer and the outer layer of the board of the present invention;

FIG. 4 shows another embodiment of the reinforcement layer and the outer layer of the board of the present invention;

FIG. 4A is a cross sectional view to show a second embodiment of the reinforcement layer;

FIG. 4B is a cross sectional view to show a third embodiment of the reinforcement layer;

FIG. 5 is a cross sectional view to show a fourth embodiment of the reinforcement layer;

FIG. 5A shows control fins are connected to the bottom of the rear end of the board;

FIG. 6A shows a fifth embodiment of the reinforcement layer of the present invention;

FIG. 6B shows a sixth embodiment of the reinforcement layer of the present invention;

FIG. 6C shows a seventh embodiment of the reinforcement layer of the present invention;

FIG. 7 shows that the board is used as a surfboard, and

FIG. 8 shows that the board is used as a wind surfboard.

### DETAILED DESCRIPTION OF THE PREFERRED EMBODIMENT

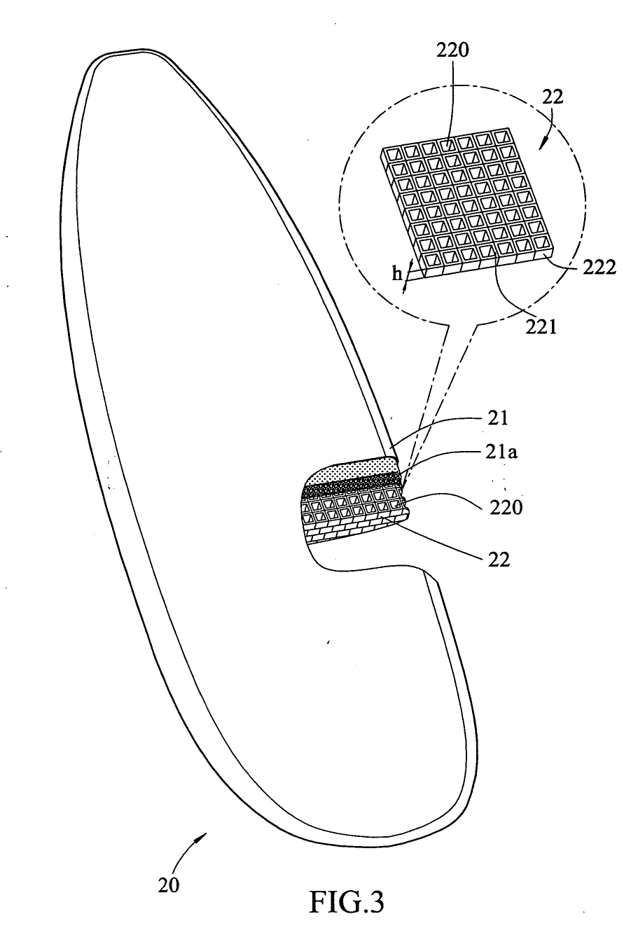

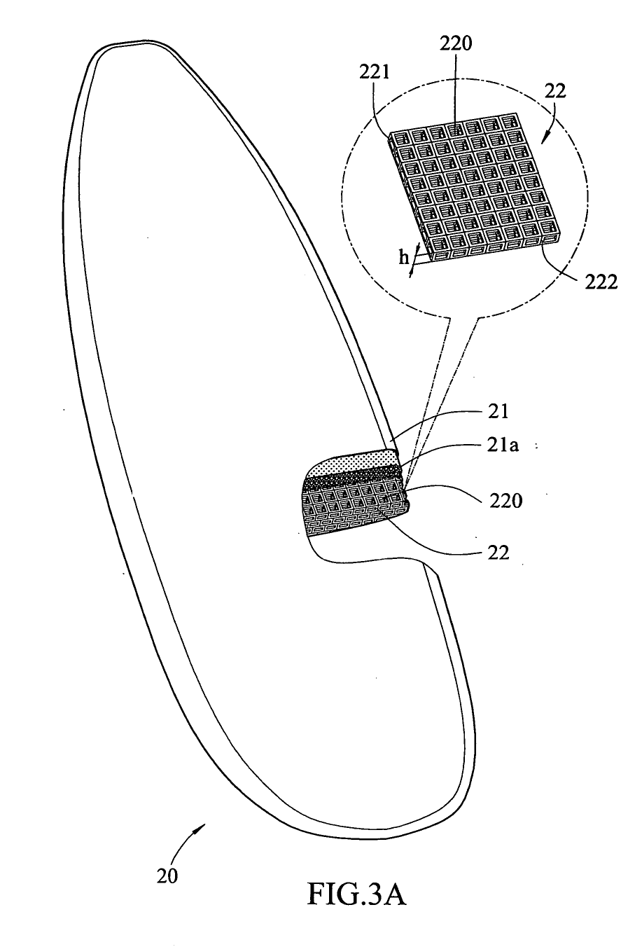

Referring to FIG. 3, the board 20 of the present invention comprises a reinforcement layer including a plurality of reinforcement blocks 22 overlapped with each other and each reinforcement block 22 includes a plurality of ribs 221 arranged to define a plurality of chambers 220 therebetween. Each reinforcement block 22 is made to have a proper height “h” and multiple reinforcement blocks 22 can be overlapped as desired. An outer layer 21 encloses the reinforcement layer and includes an inner layer 21A which seals the chambers 220. An outside wall 222 is connected to an outer periphery of each of the reinforcement blocks 22 to increase the structural strength thereof. The ribs 221 are substantially perpendicular to a top surface and a bottom surface of the board 20. Any two adjacent chambers 222 of the reinforcement blocks 22 has a separate wall located therebetween.

As shown in FIG. 3A, the outside wall 222 and the separate walls can be omitted to form a more light reinforcement block 22.

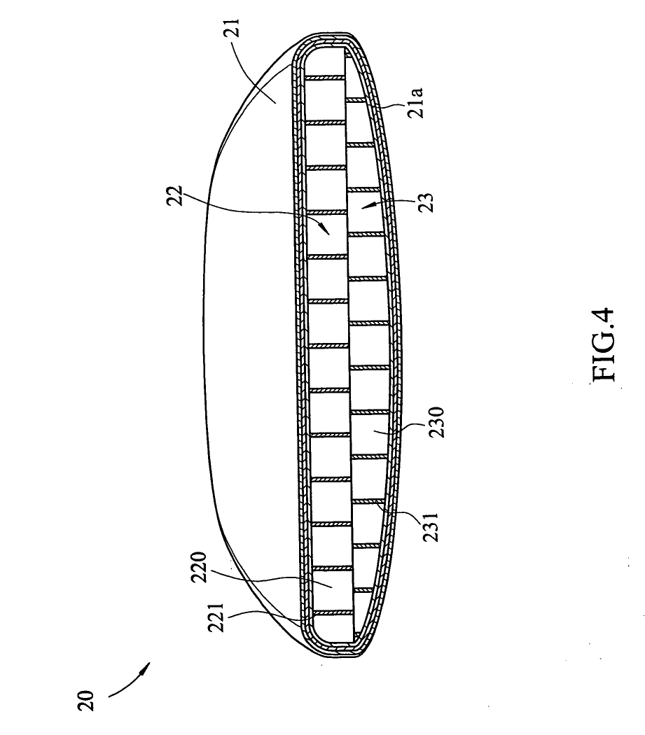

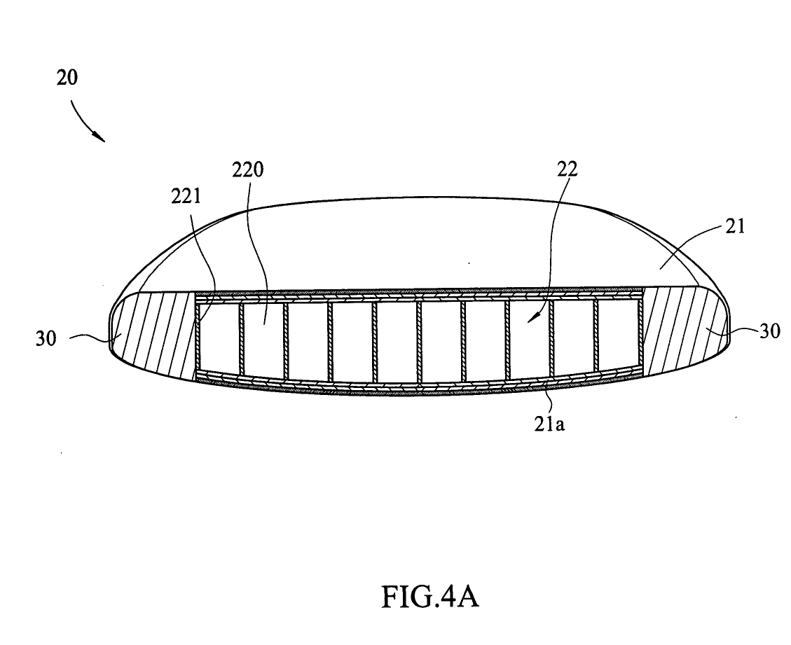

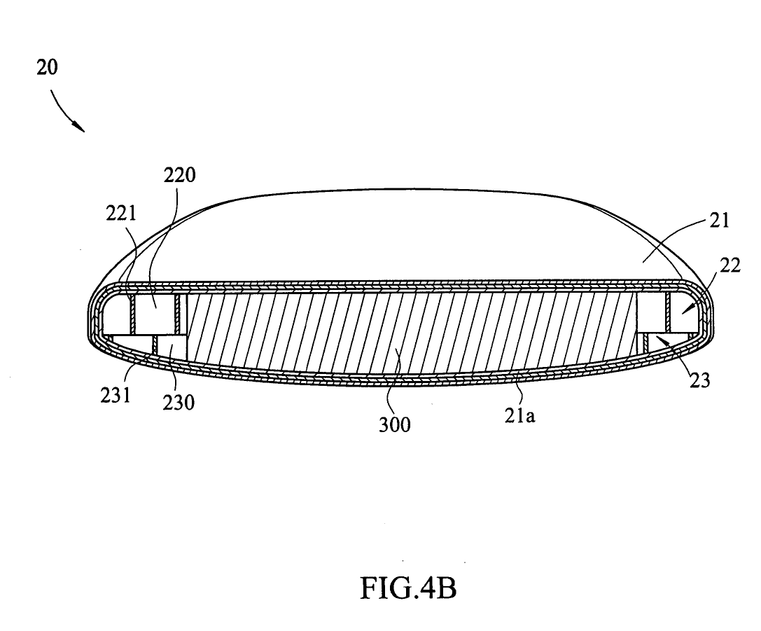

FIG. 4 shows that the reinforcement layer includes two reinforcement blocks 22, 23 overlapped with each other and the ribs 221, 231 and the chambers 220, 230 of the two reinforcement blocks 22, 23 are located alternatively. FIG. 4A shows that the reinforcement layer includes two side blocks 30 located on two sides of the reinforcement block 22.

FIG. 4B shows that the reinforcement layer includes two pairs of reinforcement blocks 22, 23 overlapped with each other and a central piece 30 is located between the two pairs of the reinforcement blocks 22, 23.

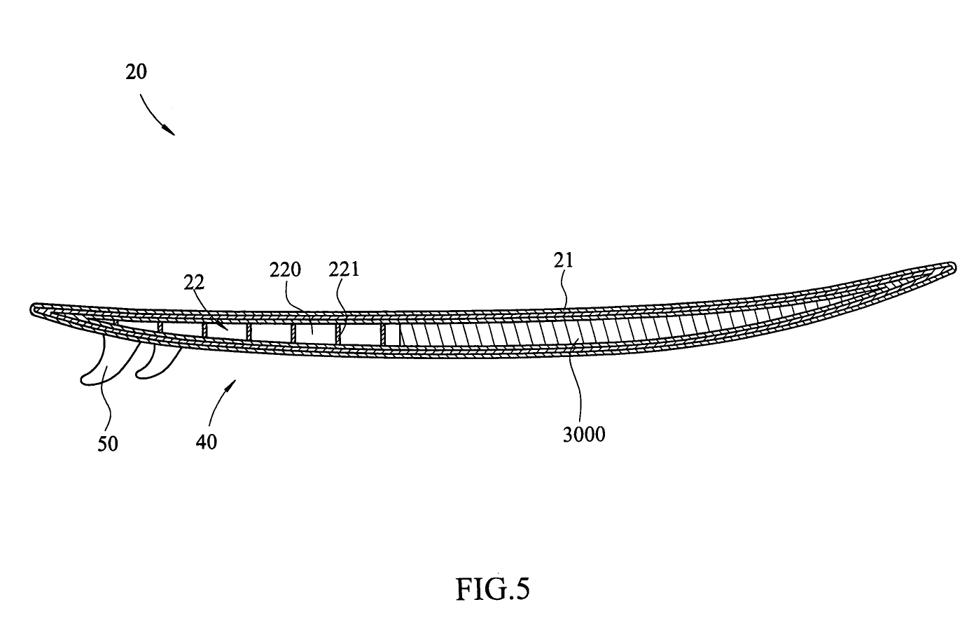

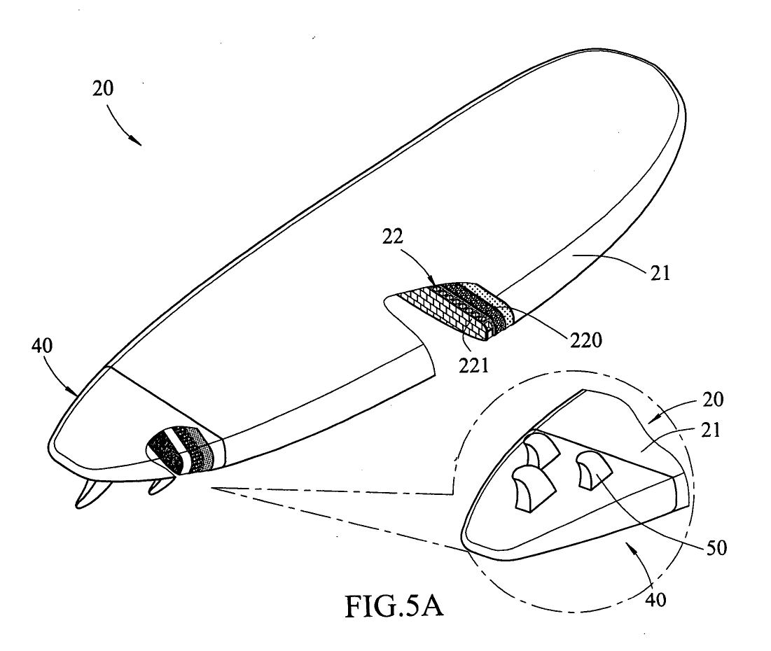

FIGS. 5 and 5A show that the reinforcement block 22 is located close to a rear end 40 of the board 20 and a solid piece 3000 is located close to a front end of the board 20. A plurality of control fins 50 are connected to an underside of the rear end 40 of the board 20.

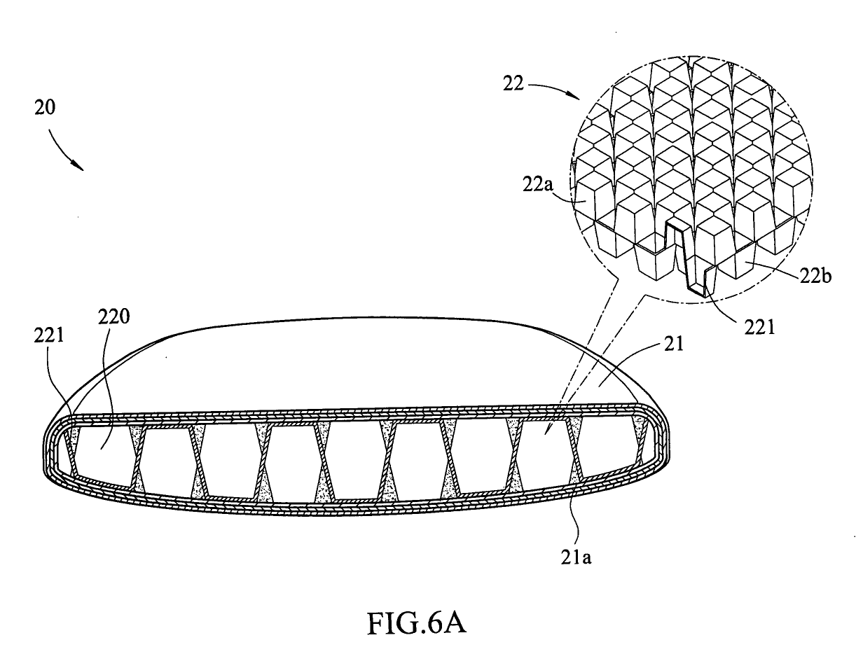

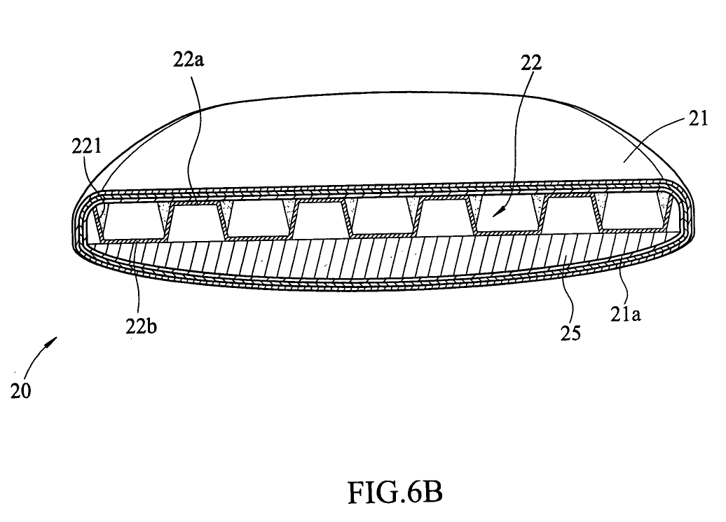

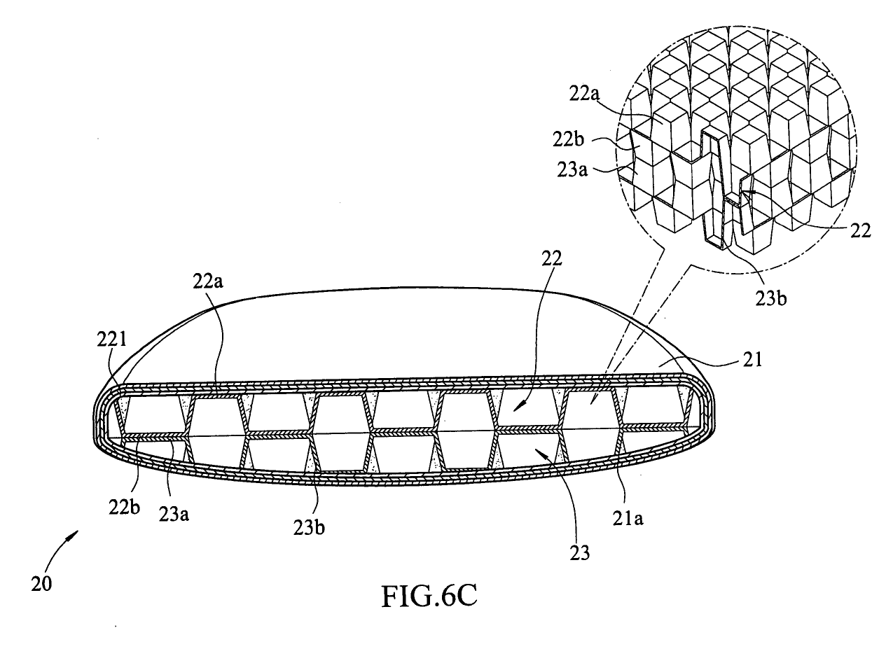

FIG. 6A shows that the reinforcement block 22 which includes a plurality of trapezoid-shaped ribs 221, viewed from either side of the reinforcement block 22, so as to define a plurality of protrusions 22a, 22b on a top and a bottom of the at least one reinforcement block 22. The protrusions 22a on the top has a close top and an open bottom, and the protrusions 22b on the bottom has a close bottom and an open top. An outer layer 21 encloses the reinforcement layer.

FIG. 6B shows that the reinforcement layer includes a solid piece 25 located at an underside of the reinforcement block 22. FIG. 6C shows that two reinforcement blocks 22 are overlapped with each other and the protrusions 22b of the upper reinforcement block 22 are in contact with the protrusion 23a on a top of the reinforcement block 23 at the bottom.

The material of the outer layer 21 can be rubber, plastic, epoxy, polymer, polyester, glass fibers, carbon fibers or any known composite material. The material of the reinforcement blocks 22, 23 can be plastic, paper-boards or composite material. The shapes of the protrusions can be any polygonal shapes.

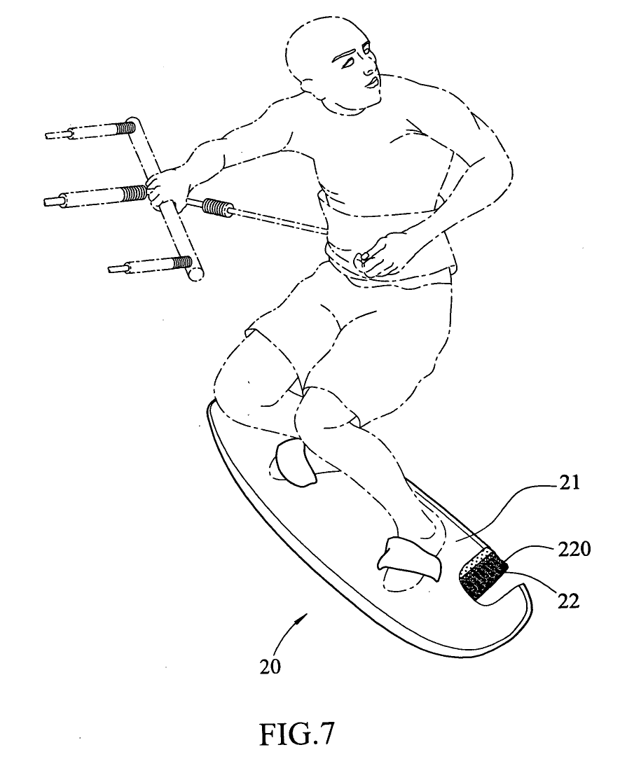

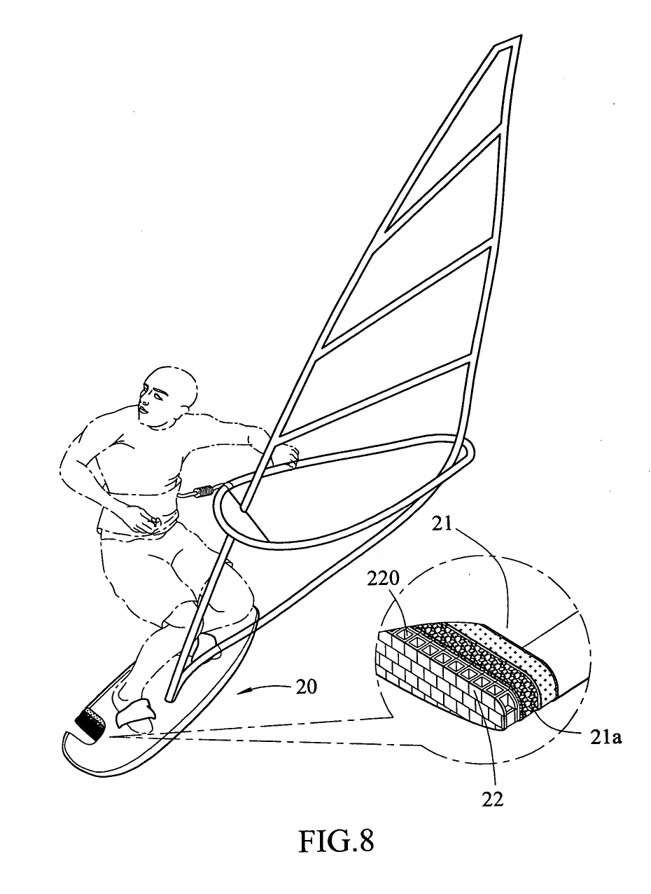

FIGS. 7 and 8 show that the board 20 of the present invention are used as a surfboard or windsurf board.

While we have shown and described the embodiment in accordance with the present invention, it should be clear to those skilled in the art that further embodiments may be made without departing from the scope of the present invention.

1. A waterboard structure having opposing top and bottom surfaces, comprising:
a reinforcement layer including at least one reinforcement block which includes a plurality of ribs extending in both a longitudinal direction and a lateral direction to define a plurality of chambers therebetween, the top and bottom surfaces of the waterboard being transaxial to a respective axis of the plurality of chambers, and
an outer layer enclosing the reinforcement layer, the ribs extending in a direction intersecting the top surface and the bottom surface of the waterboard.

2. The waterboard structure as claimed in claim 1, wherein an outside wall is connected to an outer periphery of the at least one reinforcement block.

3. A waterboard structure having opposing top and bottom surfaces, comprising:
a reinforcement layer formed by a plurality of reinforcement blocks arrayed in both a longitudinal direction and a lateral directions, each of the plurality of reinforcement blocks having peripheral side walls defining a respective chamber therein, the top and bottom surfaces of the waterboard being transaxial to a respective axis of the plurality of chambers, any two adjacent chambers of the plurality of reinforcement blocks having a pair of adjacent walls located therebetween, and
an outer layer enclosing the reinforcement layer, the peripheral side walls of the plurality of reinforcement blocks extending in a direction intersecting the top surface and the bottom surface of the waterboard.

4. The waterboard structure as claimed in claim 3, wherein the reinforcement layer includes two layers of reinforcement blocks one overlaying the other and the peripheral side walls of the reinforcement blocks of one layer of reinforcement blocks being located in nonaligned relationship with respect to the peripheral side walls of the plurality of reinforcement blocks of the other layer.

5. The waterboard structure as claimed in claim 1, wherein the reinforcement layer includes two side blocks located on two sides of the at least one reinforcement block.

6. The waterboard structure as claimed in claim 3, wherein the reinforcement layer is disposed on two peripheral sides of the waterboard with a central piece is located therebetween.

7. The waterboard structure as claimed in claim 1, wherein the at least one reinforcement block is located adjacent to a rear end of the board and a solid piece is located adjacent to a front end of the board.

8. The waterboard structure as claimed in claim 7, wherein a plurality of control fins are connected to an underside of the rear end of the board.

9. A waterboard having opposing top and bottom surfaces, comprising:
a reinforcement layer formed by a first two layers of reinforcement blocks overlaid one upon another, each layer of reinforcement blocks being arrayed in both a longitudinal direction and a lateral direction, each of the plurality of reinforcement blocks having peripheral trapezoid-shaped side walls, a closed end and an open end, the open ends of the plurality of reinforcement blocks of one layer of reinforcement blocks respectively facing the open ends of the other layer of reinforcement blocks to define a plurality of protrusions on a top and a bottom of the reinforcement layer, and
an outer layer enclosing the reinforcement layer.

10. The waterboard structure as claimed in claim 9, further comprising a solid piece located at an underside of the reinforcement layer.

11. The waterboard structure as claimed in claim 9, wherein the reinforcement layer includes a second two layers of reinforcement blocks overlaying the first two layers of reinforcement blocks, the closed ends of a lower layer of the second two layers being disposed on the closed ends of an upper layer of the first two layers.
